(19) United States
(12) Patent Application Publication
(10) Pub. No.: US 2014/0299231 A1
(43) Pub. Date: Oct. 9, 2014

(54) METAL-BASED SOLDER COMPOSITE INCLUDING CONDUCTIVE SELF-HEALING MATERIALS

(71) Applicant: Samsung Electronics Co., Ltd., Suwon-Si (KR)

(72) Inventors: Kun-mo CHU, Seoul (KR); Chang-youl MOON, Suwon-si (KR); Sung-hee LEE, Suwon-si (KR); Jun-sik HWANG, Hwaseong-si (KR)

(73) Assignee: SAMSUNG ELECTRONICS CO., LTD., Suwon-Si (KR)

(21) Appl. No.: 14/077,846

(22) Filed: Nov. 12, 2013

(30) Foreign Application Priority Data
Apr. 5, 2013 (KR) 10-2013-0037650

(51) Int. Cl. B23K 35/02

(52) U.S. Cl. CPC B23K 35/0222
USPC 148/23

(57) ABSTRACT

A solder composite is provided. The solder composite may include: a metal-based solder matrix, a capsule dispersed in the solder matrix, and a self-healing material that is encapsulated in the capsule. The self-healing material may be configured to react with the solder matrix when in contact with the solder matrix such that at least one of an electrically conductive intermetallic compound and an electrically conductive alloy is formed.

### CROSS-REFERENCE TO RELATED APPLICATIONS

This application claims the benefit of Korean Patent Application No. 10-2013-0037650, filed on Apr. 5, 2013, in the Korean Intellectual Property Office, the disclosure of which is incorporated herein in its entirety by reference.

### BACKGROUND

1. Field

The example embodiments relate to a solder composite.

2. Description of the Related Art

Solder is used to provide an electric and/or mechanical bonding among metal parts and generally includes a meltable metal alloy. A method of boding by using solder is referred to as soldering. In conventional soldering, soft solder with a melting point below 450° C. is used. During soldering, the solder melted by heating permeates between metal parts and cools down therein, thereby forming a solder junction. The solder junction provides an electric and/or mechanical bonding among metal parts.

An external impact may be applied to a solder junction. In addition, an internal stress due to thermal expansion may be generated in the solder junction. Thus, the solder junction may be damaged. Damage in the solder junction can rapidly increase the electric resistance of the solder junction and also can drastically reduce the mechanical strength of the solder junction. Accordingly, when the solder junction is damaged, rework of the solder junction is usually required. When rework is not possible, products including damaged solder junctions are often discarded. Rework of the damaged solder junctions and discarding products including the damaged solder junctions may result in wasted money and time. Furthermore, non-discarded products, including damaged solder junctions, may unexpectedly malfunction.

### SUMMARY

Example embodiments include a solder composite including an electrically conductive self-healing material.

According to an example embodiment, a solder composite is provided. The solder composite may include: a metal-based solder matrix, a capsule dispersed in the solder matrix, and a self-healing material that is encapsulated in the capsule. The self-healing material may be configured to react with the solder matrix when in contact with the solder matrix such that at least one of an electrically conductive intermetallic compound and an electrically conductive alloy is formed.

According to another example embodiment, a solder composite is provided. The solder composite may include a metal-based solder matrix, a capsule dispersed in the solder matrix, and a self-healing material encapsulated in the capsule. The self-healing material may include electrically conductive solid particles and a solvent.

According to another example embodiment, a solder composite is provided. The solder composite may include, a metal-based solder matrix, a capsule dispersed in the solder matrix, and at least two self-healing materials encapsulated in the capsule. The at least two self-healing materials selected from the group comprising (i) a first self-healing material that forms an electrically conductive intermetallic compound by reacting with the solder matrix when in contact with the solder matrix; (ii) a second self-healing material that forms an electrically conductive alloy by reacting with the solder matrix when in contact with the solder matrix; and (iii) a third self-healing material including electrically conductive solid particles and a solvent.

Example embodiments will be set forth in part in the description which follows and may be learned by practice of the presented embodiments.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description.

It will be understood that, although the terms first, second, third, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order as described. For example, two operations described in succession may in fact be executed substantially concurrently or may sometimes be executed in the reverse order, depending upon the functionality/acts involved.

Reference will now be made in detail to embodiments. In this regard, the present embodiments may have different forms and should not be construed as being limited to the descriptions set forth herein. Accordingly, the embodiments are merely described below to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

According to exemplary embodiments, a solder composite including self-healing materials has a self-healing function in comparison to a conventional solder paste material. When a crack occurs in a solder junction formed by using an embodiment of a solder composite, among capsules contained in the solder junction, the capsules disposed over the crack break and self-healing materials from the broken capsules flow out and fill the crack. The, the self-healing materials that filled the crack react with a solder matrix, and become consolidated while forming an intermetallic compound. Accordingly, the crack generated in the solder junction formed by using an embodiment of a solder composite can be automatically healed by the consolidated self-healing materials. In addition, the intermetallic compound formed by the reaction between the self-healing materials and the solder matrix has electric conductivity, and thus, the healed solder junction can still retain excellent electric conductivity. As a result, the solder junction formed by using an embodiment of a solder composite may have advantages in terms of protection, and maintenance and repair of electronic packages due to its self-healing function.

A solder composite according to an example embodiment may include a metal-based solder matrix, a capsule dispersed in the solder matrix, and a self-healing material that is encapsulated in the capsule and forms an electrically conductive intermetallic compound or electrically conductive alloy by reacting with the solder matrix when in contact with the solder matrix.

In an example embodiment, a metal-based solder matrix may be any metal-based solder material. The metal-based solder matrix may be in the form of a paste. According to various embodiments, the metal-based solder matrix, may include lead-tin (Pb—Sn) based materials. Such embodiments may have an atomic ratio in the range of 5.0≦Pb≦65.0, 35.0≦Sn≦95.0. According to various embodiments, the metal-based solder matrix may include lead-indium (Pb—In) based materials. Such embodiments may have an atomic ratio in the range of 30.0≦Pb≦95.0, 5.0≦In≦70. According to various embodiments, the metal-based solder matrix, may include indium-tin (In—Sn) based materials. Such embodiments may have an atomic ratio in the range of 8.0≦In≦52.0, 48.0≦Sn≦92.0. According to various embodiments, the metal-based solder matrix may include indium-gallium (In—Ga) based materials. Such embodiments may have an atomic ratio in the range of 5.0≦In≦99.5, 0.5≦Ga≦95.0. According to various embodiments, the metal-based solder matrix may include tin-silver (Sn—Ag) based materials. Such embodiments may have an atomic ratio in the range of 95.0≦Sn≦97.5, 2.5≦Ag≦5.0. According to various embodiments, the metal-based solder matrix may include indium-silver (In—Ag) based materials. Such embodiments may have an atomic ratio in the range of 90.0≦In≦97.0, 3.0≦Ag≦10.0. According to various embodiments, the metal-based solder matrix may include tin-copper (Sn—Cu) based materials. Such embodiments may have an atomic ratio in the range of 91.0≦Sn≦99.5, 0.5≦Cu≦9.0. The materials discussed above may have a melting point of about 250° C. or less.

In an example embodiment, the metal-based solder matrix materials may be a low melting point solder to prevent thermal damage of a capsule in a reflow process. For example, the low melting point solder may be an indium and tin-based solder or a nano silver paste.

In an example embodiment, the capsule may be dispersed in a solder matrix. In addition, the capsule may include a self-healing material, and the capsule and the a self-healing material may include a capsule phase and a self-healing material phase, respectively. The self-healing material phase may be separated from the solder matrix phase by the capsule.

The capsule may be a closed object including a solid, a liquid, a gas, or a combination thereof. The capsule may have a short axis and a long axis that may not cross each other at a right angle. An aspect ratio of the capsule (the ratio between the short axis and the long axis) may be, for example, in the range of about 1:1 to about 1:10. The capsule is not limited to a particular shape. For example, the capsule may be in the form of a sphere, a toroid, an irregular amoeba, and the like. The diameter of the capsule (along the short axis or the long axis) may be, for example, in the range of about 10 nm to about 500 μm.

In an example embodiment, a capsule material may be a polymer or ceramic. In an example embodiment, the capsule material may be a polymer material such as polyurethanes, melamine-formaldehyder resins, urea-formaldehyde resins, gelatin, polyureas, polystyrenes, polydivinylbenzenes polyamides, or other like polymers. According to various embodiments, the capsule material may be a ceramic such as SiO₂, TiO₂, Al₂O₃, ZrO₂, or other like ceramic.

Additionally, the temperature of the reflow process may be determined by the melting point of a solder matrix material. Preferably, the capsule material should not be broken by heat under the temperature of the reflow process. When the temperature of the reflow process is high (for example, about 200° C. or above), a suitable capsule material may be a ceramic material which is less damaged by heat.

In an example embodiment, the capsule may have a wall thickness in the range of about 0.1 nm to about 5 μm, more specifically, about 0.1 μm to about 5 μm. When the wall of the capsule is too thick, the capsule may not break even when a crack is generated in the solder junction. In contrast, when the wall of the capsule is too thin, the capsule may break during a reflow process.

When an adhesion between the capsule and the solder matrix material is weak, the capsule may not break even when a crack is generated in the solder junction. In order to increase the adhesion between the capsule and the solder matrix material, an adhesion promoter, such as an unsaturated silane coupling agent and the like, may be coated on the surface of the capsule.

The self-healing material may be included in the capsule. The self-healing material may include any material which can form an electrically conductive intermetallic compound by reacting with a metal-based solder matrix when the self-healing material is in contact with the metal-based solder matrix.

According to various embodiments, the self-healing material may a liquid metal. A liquid metal is a metal which is in a liquid state at room temperature (e.g., at 25° C. standard atmosphere unit (atm), and the like). For example, the liquid metal may include a eutectic gallium-indium (Ga—In) alloy, a eutectic gallium-silver (Ga—Ag) alloy, a eutectic gallium-tin (Ga—Sn) alloy, or gallium (Ga). More specifically, according to various embodiments, in a eutectic Ga—In alloy, the atomic ratio of Ga to In may be about 75:about 25, or about 95:about 5. The melting point of the eutectic Ga—In alloy may be about 15.3° C., and thus, the alloy may easily leak out of the broken capsule, and form an intermetallic compound with an Indium-based solder matrix. For example, the intermetallic compound formed from the metal-based solder matrix and the liquid metal may include Ag₃Ga₂, or In_{99.5}Ga_{0.5}. The melting point of the intermetallic compound between the metal-based solder matrix and the liquid metal may be, for example, about 301° C. for Ag₃Ga₂, or about 154° C. for In_{99.5}Ga_{0.5}. In addition, the intermetallic compound between the metal-based solder matrix and the liquid metal may have superior electric conductivity.

According to various embodiments, the self-healing material may be, for example, a low melting point solder having a melting point lower than that of the metal-based solder matrix. Specifically, for example, the low melting point solder may be a bismuth-tin (Bi—Sn) alloy, an indium-gallium (I—Ga) alloy, indium-tin (In—Sn) alloy, an indium-bismuth (In—Bi) alloy, an indium-silver (In—Ag) alloy, or a tin-silver (Sn—Ag) alloy. More specifically, for example, in a eutectic Bi—Sn alloy, the atomic ratio of Bi to Sn may be about 1:0.19 to about 1:0.72. Upon generation of one or more cracks in the solder junction, when the entire temperature of a package is increased to become equal to or higher than a melting point of a low melting point solder, the low melting point solder may melt and leak out of the broken capsule, fill one or more cracks, and form a three-membered alloy with a metal-based solder matrix material. Specifically, for example, a low melting point solder of a eutectic Bi—Sn alloy can form an indium-gallium-tin (In—Ga—Sn), an indium-bismuth-tin (In—Bi—Sn), an indium-bismuth-lead (In—Bi—Pb), a lead-bismuth-tin (Pb—Bi—Sn), or an indium-gallium-silver (In—Ga—Ag) three-membered alloy by reacting with an In-based or an In—Pb-based solder matrix. An alloy between the low melting point solder and the metal-based solder matrix may be, for example, GaInSn, BiInPb, BiPbSn, InPbSn, or InAgGa. A melting point of an alloy between the low melting point solder and the metal-based solder matrix may be, for example, about 10.7° C. for GaInSn, about 73° C. for BiInPb, about 95° C. for BiPbSn, about 120° C. for InPbSn, and about 381° C. for InAgGa. Furthermore, an alloy between a low melting point solder and a metal-based solder matrix may have superior electric conductivity.

The total amount of the self-healing material contained in the capsule may be about 0.5 part by weight to about 10 parts by weight relative to 100 parts by weight of the metal-based solder matrix.

When the amount of the self-healing material is too small, the self-healing effect may not be significant. In contrast, when the amount of the self-healing material is too large, the solder junction may deteriorate in terms of its electric conductivity, bonding strength, tensile strength, and the like, due to the increased amount of the capsule.

A second embodiment of a solder composite according to an example embodiment will be described in further detail. The second embodiment of a solder composite according to an aspect of the present disclosure may include a metal-based solder matrix, a capsule dispersed in the solder matrix, and a self-healing material encapsulated in the capsule. The self-healing material may include electrically conductive solid particles and a solvent.

A metal-based solder matrix and a capsule dispersed in the metal-based solder matrix are similar or the same as the metal-based solder matrix and the capsule described above.

A self-healing material according to the second embodiment may include electrically conductive solid particles and a solvent. The electrically conductive solid particles may be carbon nanotube, carbon nanofiber, graphite, graphene, fullerene or carbon black. The solvent may be ethyl phenylacetate (EPA, C₂₀H₃₀O₂), chlorobenzene (PhCl, C₆H₅Cl), and the like. In the self-healing material including the electrically conductive solid particles and a solvent, a content of the electrically conductive solid particles may be about 0.05 wt % to about 10 wt %.

According to the percolation theory, when a content of the electrically conductive solid particles is above a certain value, a rapid increase in the electric conductivity of the self-healing material may occur. In contrast, when the solid content is too low, the resulting effect may not be significant. The increase in the solid content leads to a strong interaction between the solid particles, which may cause agglomeration of the solid particles, thus, preventing a uniform dispersion of the solid particles in the solvent. As a result, the electric conductivity of the self-healing material may reach a saturation point. Furthermore, the increase in the solid content leads to an increase in viscosity of the self-healing material containing the solvent, thus, preventing the self-healing material from leaking out the broken capsule.

The self-healing material containing the electrically conductive solid particles and the solvent may have good flowability. Therefore, the self-healing material can easily flow out of the broken capsule and fill a crack. Accordingly, the solvent is evaporated, and the electrically conductive solid particles remain in the crack. The remaining electrically conductive solid particles may compensate for the electric conductivity lost due to the crack.

A third example embodiment will be described below. In the third embodiment of a solder composite may include a metal-based solder matrix, a capsule dispersed in the solder matrix, and a self-healing material encapsulated in the capsule. The self-healing material may include at least two self-healing materials selected from the group consisting of (i) a self-healing material, which, when in contact with the solder matrix, forms an electrically conductive intermetallic compound by reacting with the solder matrix; (ii) a self-healing material, which, when in contact with the solder matrix, forms an electrically conductive alloy by reacting with the solder matrix; and (iii) a self-healing material, which includes electrically conductive solid particles and a solvent.

Example embodiments of a solder composite is further described herein below.

### Preparation of a Capsule Containing a Self-Healing Material

A self-healing material containing a liquid metal, a melted low melting point solder, and/or a suspension containing electrically conductive solid particles and a solvent, is added into a polymer solution while stirring. Droplets of the self-healing material are dispersed in the polymer solution. A solvent for the polymer solution may be selected from among solvents that will not dissolve the self-healing material. As an alternative, the solvent may be selected from among solvents which are not miscible with the self-healing material. The mixture of the polymer solution and the self-healing material is then cooled down, and the droplets dispersed in the polymer solution are consolidated. The droplets of the consolidated self-healing material are separated from the polymer solution by, for example, filtration, centrifugation, and/or the like. The droplets of the consolidated self-healing material are surface-coated with the polymer solution. The solvent in the polymer solution coated on the surface of the droplets of the consolidated self-healing material is removed by, for example, drying, evaporation, volatilization, and/or the like, thereby obtaining a polymer capsule containing the self-healing material. The size of the polymer capsule may depend on the size of the droplets of the self-healing material, and the size of the droplets of the self-healing material may be controlled by the stirring speed.

In an example embodiment, an inorganic material capsule may be prepared as shown in Korean Patent Application Publication No. 10-2010-0112707, which is now incorporated by reference. There are various methods to enclose a self-healing material containing a liquid metal, a low melting point solder, or a suspension containing electrically conductive solid particles and a solvent with an inorganic material. However, the affinity of the above-mentioned self-healing material with silica is not high. Therefore, in order to increase the affinity of the self-healing material with an inorganic material, such as a silica precursor having a negative charge, the surface of the self-healing material may be treated with a cationic compound by using a coupling agent. Although the used material is not the same, Chem. Comm., ((2003), pp. 1010˜1011) discloses, for example, a method for encapsulating the surface of polystyrene particles, the method including: preparing polystyrene particles with a size of about 0.1 to about 1 μm via emulsifier-free emulsion polymerization while introducing a functional group of —NH₂/—COOH or —NH₂, and adding the polystyrene particles into a sodium silicate to precipitate salicylic acid on the particle surface and converting it to a silica, thereby encapsulating the surface of polystyrene particles.

According to example embodiments, a self-healing material may be added to a solvent to be dispersed therein, and a surfactant and an alkaline solution, such as NH₄OH, may be added to the sufficiently dispersed solution, and stirred. The solvent may be an alcohol, such as ethanol, water, a mixture water and ethanol, a cyclohexane solution, or other like solvents. In performing silica coating, when the amount of the alkaline solution is not sufficient, the resulting product may not be uniform in shape and size, and thus, a suitable amount of the alkaline solution may be added. In silica coating using tetraethyl orthosilicate (TEOS), silica-coating of the self-healing material may be possible if the surface of the self-healing material is modified by using a surfactant such as Igepal Co-520(poly(oxyethylene)nonylphenyl ether). In the surface modification of the self-healing material, the thickness of the silica may be controlled by adjusting the amount of the TEOS and the surfactant. The alkaline solution is added and stirred, for example, for about 5 minutes to 2 hours, then, TEOS is added thereto and stirred, for example, for about 1 to about 30 hours. Here, when the stirring is strongly performed, the resulting silica coating may not be uniform in shape and size. In contrast, when the stirring is too slow, the thickness of the silica coating may not be uniform. Therefore, the stirring may be performed at a speed of about 50 to about 1000 rpm.

### Preparation of a Metal-Based Solder Matrix

After mixing a solder matrix material and ethanol in a volume ratio of 4(solder):6(ethanol), alumina balls are added to the solder solution. Then, the solder solution including the alumina balls is subject to ball milling. Upon completion of the ball milling, the alumina balls are removed from the solder solution using a filter screen. Then, the solder solution is heated at about 80° C. to evaporate ethanol therein, and the solder solution is vacuum dried for at least 4 hours, thereby obtaining a solder matrix material powder.

Preparation of a flux for a solder paste

A flux may serve to prevent re-oxidation of metals while heating during the soldering process of removing an oxidized film on the base metal surface, and may also lower the surface tension of the melted soldering material, thereby improving the expansion (spreadability or wettability) of the soldering material. According to various embodiments, when preparing a flux for a solder paste, the flux is obtained by mixing a resin, a plasticizer, a solvent, an activator, a thixotropic agent, a dispersant, etc. First, a plasticizer and a solvent are stirred to be mixed on a hot plate kept at 150˜210° C. After adding an activator, the activator may be dissolved, for example, by stirring at 100˜160 rpm for about 5˜35 minutes. Upon dissolution of the activator, a resin and a dispersant are added thereto, dissolved for about 5˜35 minutes without stirring, and then stirred at 200˜400 rpm for 5˜20 minutes. Upon dissolution of the resin and the dispersant, a thixotropic agent is added thereto and dissolved by stirring at 300˜500 rpm for 5˜20 minutes. Upon dissolution of the thixotropic agent, the resultant is removed from the hot plate, stabilized at room temperature, thereby obtaining a flux for a solder paste. An amount of the flux for a solder paste to be used may be, for example, about 1 to about 15 parts by weight relative to 100 parts by weight of the total weight of the capsule including the self-healing material and the solder matrix.

### Preparation of a Solder Composite Including a Capsule Containing a Self-Healing Material

A solder composite including a capsule containing a self-healing material may be prepared by mixing a flux for a solder paste, a capsule powder for self-healing, and a solder matrix material powder. According to various embodiments, after adding a flux for a solder paste, a capsule powder for self-healing, and a solder powder into a mixer (e.g., a planetary mixer), stirring may be performed in a multiple step process by using the mixer while varying the stirring rate and/or stirring time. The stirring rate may be increased in a stepwise manner in the multiple step process. In such embodiments, a flux for a solder paste may be effectively mixed with a solder powder. Accordingly, the solder composite including the capsule containing the self-healing material is obtained.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A solder composite comprising:
a metal-based solder matrix;
a capsule dispersed in the solder matrix;
a self-healing material that is encapsulated in the capsule; and
at least one of an electrically conductive intermetallic compound and an electrically conductive alloy formed of the metal-based solder matrix and the self-healing material when the self-healing material comes in contact with the metal-based solder matrix.

2. The solder composite according to claim 1, wherein the metal-based solder matrix is one of an indium and tin-based solder and a nano silver paste.

3. The solder composite according to claim 1, wherein an aspect ratio of the capsule is in the range of 1:1 to 1:10.

4. The solder composite according to claim 1, wherein a diameter of the capsule is in the range of 10 nm to 500 μm.

5. The solder composite according to claim 1, wherein a material of the capsule is one of a polymer and a ceramic.

6. The solder composite according to claim 1, wherein a wall thickness of the capsule is in the range of 0.1 μm to 5 μm.

7. The solder composite according to claim 1, wherein the self-healing material is a liquid metal.

8. The solder composite according to claim 7, wherein the self-healing material is one of a eutectic gallium-indium alloy, a eutectic gallium-silver alloy, a eutectic gallium-tin alloy, and gallium.

9. The solder composite according to claim 1, wherein the self-healing material is a low melting point solder material having a melting point lower than a melting point of the metal-based solder matrix.

10. The solder composite according to claim 9, wherein the self-healing material is at least one of a bismuth-tin (Bi—Sn)alloy, an indium-gallium (In—Ga) alloy, indium-tin (In—Sn) alloy, an indium-bismuth (In—Bi) alloy, an indium-silver (In—Ag)alloy, and a tin-silver (Sn—Ag) alloy.

11. The solder composite according to claim 1, wherein a total amount of the self-healing material is 0.5 part by weight to 10 parts by weight relative to 100 parts by weight of the metal-based solder matrix.

12. A solder composite comprising, a metal-based solder matrix;
a capsule dispersed in the solder matrix; and
a self-healing material encapsulated in the capsule, the self-healing material including electrically conductive solid particles and a solvent.

13. The solder composite according to claim 12, wherein the electrically conductive solid particles are at least one of a carbon nanotube, a carbon nanofiber, a graphite, a graphene, a fullerene, and a carbon black.

14. The solder composite according to claim 12, wherein the solvent is at least one of ethyl phenylacetate (EPA, C₂₀H₃₀O₂) and chlorobenzene (PhCl, C₆H₅Cl).

15. The solder composite according to claim 12, wherein a content of the electrically conductive solid particles is in a range of 0.05 wt % to 10 wt %.

16. A solder composite comprising,
a metal-based solder matrix;
a capsule dispersed in the solder matrix; and
a self-healing material encapsulated in the capsule,
wherein the self-healing material includes at least two self-healing materials selected from the group consisting of (i) a self-healing material that forms an electrically conductive intermetallic compound by reacting with the solder matrix when in contact with the solder matrix; (ii) a self-healing material that forms an electrically conductive alloy by reacting with the solder matrix when in contact with the solder matrix; and (iii) a self-healing material including electrically conductive solid particles and a solvent.
